(19) United States
(12) Patent Application Publication
(10) Pub. No.: US 2025/0192947 A1
(43) Pub. Date: Jun. 12, 2025

(54) METHODS AND APPARATUS OF POWER BOOSTING FOR DMRS AND PTRS

(71) Applicant: LENOVO (BEIJING) LIMITED, Beijing (CN)

(72) Inventors: Lingling Xiao, Beijing (CN); Bingchao Liu, Beijing (CN); Chenxi Zhu, Fairfax, VA (US); Wei Ling, Beijing (CN); Yi Zhang, Beijing (CN)

(21) Appl. No.: 18/844,515

(22) PCT Filed: Apr. 30, 2022
(86) PCT No.: PCT/CN2022/090817

§ 371 Date: Sep. 6, 2024

(51) Int. Cl. H04L 5/00

(52) U.S. Cl. CPC H04L 5/0051; H04L 5/0044

(57) ABSTRACT

Methods and apparatus of power boosting for DMRS and PTRS are disclosed. The apparatus includes: a receiver that receives a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers; a processor that determines a ratio between a first Energy Per Resource Element (EPRE) of a PTRS transmission and a second EPRE of the data transmission.

### FIELD

The subject matter disclosed herein relates generally to wireless communication and more particularly relates to, but not limited to, methods and apparatus of power boosting for DMRS and PTRS.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX), Transmit or Transmitter (TX), Physical Downlink Shared Channel (PDSCH), Physical Uplink Shared Channel (PUSCH), Code-Division Multiplexing (CDM), Downlink Control Information (DCI), Demodulation Reference Signal (DMRS or DM-RS), Frequency-Division Multiplexing (FDM), Frequency Division Multiple Access (FDMA), Index/Identifier (ID), Multiple Input Multiple Output (MIMO), Orthogonal Cover Code (OCC), Resource Element (RE), Reference Signal (RS), Transmission and Reception Point (TRP), Frequency Range 1 (FR1), Frequency Range 2 (FR2), Technical Specification (TS), Energy Per Resource Element (EPRE), Phase-Tracking Reference Signal (PTRS or PT-RS), Full Duplex (FD), Frequency Division Orthogonal Cover Code (FD-OCC), Time Division Orthogonal Cover Code (TD-OCC).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP.

In Release 15, two types of DMRS are specified. DMRS type 1 includes 2 CDM groups which supports up to 8 DMRS ports and DMRS type 2 includes 3 CDM groups which supports up to 12 DMRS ports. A CDM group includes up to 4 DMRS ports which are orthogonal by FD-OCC and TD-OCC. Therefore, for single-symbol DMRS for which TD-OCC cannot be implemented, DMRS type 1 supports only up to 4 DMRS ports and DMRS type 2 supports up to 6 DMRS ports. Throughout this disclosure, “DMRS type 1” may also be referred to as “type 1 DMRS”, and the terms may be used interchangeably. Similarly, “DMRS type 2” may also be referred to as “type 2 DMRS”.

In Release 15, power boosting for DMRS is supported, which means if a CDM group does not include the DMRS ports of a PDSCH/PUSCH transmission, the power of REs corresponding to the CDM group can be borrowed for the scheduled DMRS transmission. Similarly, power boosting for PTRS is also supported. That is, for a multi-layer PDSCH/PUSCH transmission, to keep the orthogonality between data and PTRS transmission, some REs on other layers different from the PTRS transmission should be muted. The power of the muted REs on other layers of the PDSCH/PUSCH transmission can be used to boost the transmit power of the PTRS.

In Release 18, with the increasing need for multiplexing capacity of downlink and uplink DMRS from various use cases, there is a need for increasing the number of DMRS ports without increasing the DM-RS overhead. The power boosting for DMRS and PTRS may need to be enhanced with the introduction of additional DMRS ports.

### SUMMARY

Methods and apparatus of power boosting for DMRS and PTRS are disclosed.

According to a first aspect, there is provided an apparatus, including: a receiver that receives a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers; a processor that determines a ratio between a first Energy Per Resource Element (EPRE) of a PTRS transmission and a second EPRE of the data transmission.

According to a second aspect, there is provided an apparatus, including: a transmitter that transmits a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers; a processor that determines a ratio between a first Energy Per Resource Element (EPRE) of a PTRS transmission and a second EPRE of the data transmission.

According to a third aspect, there is provided a method, including: receiving, by receiver, a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers; determining, by a processor, a ratio between a first Energy Per Resource Element (EPRE) of a PTRS transmission and a second EPRE of the data transmission.

According to a fourth aspect, there is provided a method, including: transmitting, by a transmitter, a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers; determining, by a processer, a ratio between a first Energy Per Resource Element (EPRE) of a PTRS transmission and a second EPRE of the data transmission.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4A is a schematic diagram illustrating an example of DMRS ports increased in number by FDM manner for DMRS type 1 in accordance with some implementations of the present disclosure.

FIG. 4B is a schematic diagram illustrating an example of DMRS ports increased in number by FDM manner for DMRS type 2 in accordance with some implementations of the present disclosure.

FIG. 5 is a schematic diagram illustrating an example of power boosting by unused REs of additional DMRS ports for DMR type 2 in accordance with some implementations of the present disclosure.

FIG. 6 is a flow chart illustrating steps of power boosting for PTRS by UE in accordance with some implementations of the present disclosure; and

FIG. 7 is a flow chart illustrating steps of power boosting for PTRS by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

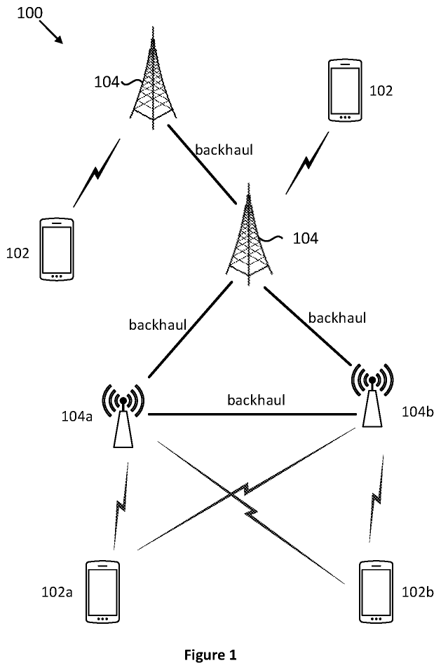

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the downlink (DL) and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

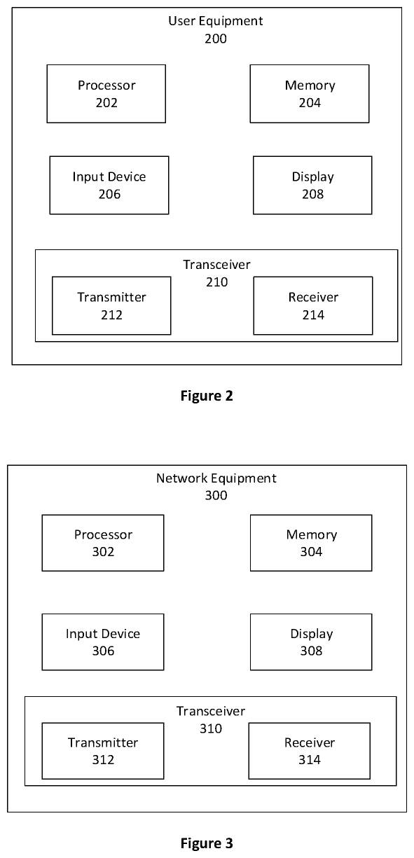

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

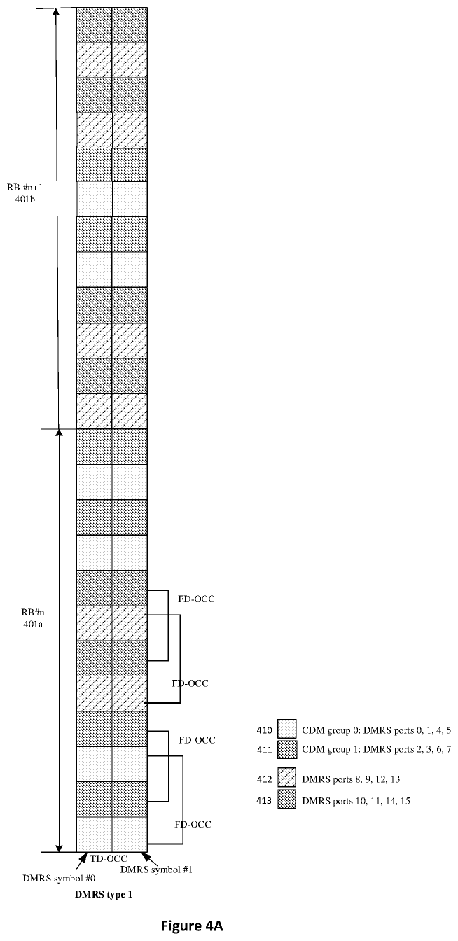

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

In Release 15, power boosting for DMRS is supported, which means if a CDM group does not include the indicated or configured DMRS ports of a PDSCH or a PUSCH transmission, the power of REs corresponding to the CDM group can be borrowed for DMRS transmission of the indicated or configured DMRS ports. That is the DMRS transmission of the indicated or configured DMRS ports can be transmitted with higher power compared to the PDSCH or the PUSCH transmission. Similarly, power boosting for PTRS is also supported. That is, for a multi-layer PDSCH or PUSCH transmission, to keep the orthogonality between data and PTRS transmission, some REs on other layers different from the PTRS transmission should be muted. The power of the muted REs on other layers of the PDSCH transmission can be used to boost the transmit power of the PTRS.

The details of power boosting for DMRS and PTRS are specified in TS 38.214 and extracted as follows.

The following is an extract from TS 38.214 relating to power allocation for downlink (4.1).

For downlink DM-RS associated with PDSCH, the UE may assume the ratio of PDSCH EPRE to DM-RS EPRE (β_{DMRS} [dB]) is given by Table 4.1-1 according to the number of DM-RS CDM groups without data as described in Clause 5.1.6.2. The DM-RS scaling factor β_{PDSCH}^{DMRS} specified in Clause 7.4.1.1.2 of [4, TS 38.211] is given by

$${β}_{PDSCH}^{DMRS} = {10}^{- \frac{{β}_{DMRS}}{20}} .$$

TABLE 4.1-1
The ratio of PDSCH EPRE to DM-RS EPRE

| Number of DM-RS CDM | DM-RS configuration | | DM-RS configuration | |
|---|---|---|---|---|
| groups without data | type 1 | | type 2 | |
| 1 | 0 | dB | 0 | dB |
| 2 | −3 | dB | −3 | dB |

| | | | |
|---|---|---|---|
| 3 | — | −4.77 | dB |

When the UE is scheduled with one or two PT-RS ports associated with the PDSCH,
if the UE is configured with the higher layer parameter epre-Ratio, the ratio of PT-RS EPRE to PDSCH EPRE per layer per RE for each PT-RS port (PPTRS) is given by Table 4.1-2 according to the epre-Ratio, the PT-RS scaling factor BPTRSspecified in clause 7.4.1.2.2 of [4, TS 38.211] is given by

$${β}_{PTRS} = {10}^{\frac{{ρ}_{PTRS}}{20}} .$$

otherwise, the UE shall assume epre-Ratio is set to state ‘0’ in Table 4.1-2 if not configured.

TABLE 4.1-2
PT-RS EPRE to PDSCH EPRE per layer per RE (ρ_{PTRS})

| | The number of PDSCH layers with DM-RS associated to the PT-RS port | | | | | |
|---|---|---|---|---|---|---|
| epre-Ratio | 1 | 2 | 3 | 4 | 5 | 6 |
| 0 | 0 | 3 | 4.77 | 6 | 7 | 7.78 |
| 1 | 0 | 0 | 0 | 0 | 0 | 0 |

| | |
|---|---|
| 2 | reserved |
| 3 | reserved |

The following is an extract from TS 38.214 relating to UE PT-RS transmission procedure when transform precoding is not enabled (6.2.3.1).

When the UE is scheduled with Qₚ={1,2} PT-RS port(s) in uplink and the number of scheduled layers is n_{layer}^{PUSCH},
If the UE is configured with higher layer parameter ptrs-Power, the PUSCH to PT-RS power ratio, per layer per RE ρ_{PTRS}^{PUSCH} is given by ρ_{PTRS}^{PUSCH}=−α_{PTRS}^{PUSCH} [dB], where α_{PTRS}^{PUSCH} is show in the Table 6.2.3.1-3 according to the higher layer parameter ptrs-Power, the PT-RS scaling factor β_{PERS} specified in clause 6.4.1.2.2.1 of [4, TS 38.211] is given by

$${β}_{PTRS} = {10}^{- \frac{{ρ}_{PTRS}^{PUSCH}}{20}}$$

and also on the ‘Precoding Information and Number of Layers’ field in DCI.
The UE shall assume ptrs-Power in PTRS-UplinkConfig is set to state “00” in Table 6.2.3.1-3 if not configured or in case of non-codebook based PUSCH.

TABLE 6.2.3.1-3
Factor related to PUSCH to PT-RS power ratio per layer per RE α_{PTRS}^{PUSCH}

| | | The number of PUSCH layers (n_{layer}^{PUSCH}) | | | | | | |
|---|---|---|---|---|---|---|---|---|
| | | 2 | | 3 | | | | |
| | | | Partial | | Partial and | 4 | | |
| | | | and non- | | non- | | | Non- |
| UL- | | | coherent | | coherent | | | coherent |
| PTRS- | 1 | | and non- | | and non- | | | and non- |
| power/ | All | Full | codebook | Full | codebook | Full | Partial | codebook |
| α_{PTRS}^{PUSCH} | cases | coherent | based | coherent | based | coherent | coherent | based |
| 00 | 0 | 3 | 3Qₚ-3 | 4.77 | 3Qₚ-3 | 6 | 3Qₚ | 3Qₚ-3 |
| 01 | 0 | 3 | 3 | 4.77 | 4.77 | 6 | 6 | 6 |

| | |
|---|---|
| 10 | Reserved |
| 11 | Reserved |

The following is an extract from TS 38.214 relating to DM-RS reception procedure (5.1.6.2).

If a UE receiving PDSCH scheduled by DCI format 1_2 is configured with the higher layer parameter phaseTrackingRS in dmrs-DownlinkForPDSCH-MappingTypeA-DCI-1-2 or dmrs-DownlinkForPDSCH-MappingTypeB-DCI-1-2 or a UE receiving PDSCH scheduled by DCI format 1_0 or DCI format 1_1 is configured with the higher layer parameter phaseTrackingRS in dmrs-DownlinkForPDSCH-MappingTypeA or dmrs-DownlinkForPDSCH-MappingTypeB, the UE may assume that the following configurations are not occurring simultaneously for the received PDSCH:
any DM-RS ports among 1004-1007 or 1006-1011 for DM-RS configurations type 1 and type 2, respectively are scheduled for the UE and the other UE(s) sharing the DM-RS REs on the same CDM group(s), and
PT-RS is transmitted to the UE.

The following is an extract from TS 38.214 relating to UE DM-RS transmission procedure (6.2.2).

For uplink DM-RS with PUSCH, the UE may assume the ratio of PUSCH EPRE to DM-RS EPRE (β_{DMRS} [dB]) is given by Table 6.2.2-1 according to the number of DM-RS CDM groups without data. The DM-RS scaling factor β_{PUSCH}^{DMRS} specified in clause 6.4.1.1.3 of [4, TS 38.211] is given by

$${β}_{PUSCH}^{DMRS} = {10}^{- \frac{{β}_{DMRS}}{20}} .$$

TABLE 6.2.2-1
The ratio of PUSCH EPRE to DM-RS EPRE

| Number of DM-RS CDM | DM-RS configuration | | DM-RS configuration | |
|---|---|---|---|---|
| groups without data | type 1 | | type 2 | |
| 1 | 0 | dB | 0 | dB |
| 2 | −3 | dB | −3 | dB |

| | | | |
|---|---|---|---|
| 3 | — | −4.77 | dB |

In Release 18, there is a need for increasing the number of DMRS ports without increasing the DM-RS overhead. The potential methods to increase the number of DMRS ports may be by FDM or CDM manner. If FDM manner is used to increase the number of DMRS ports, and if the newly introduced additional DMRS ports are not used for a data transmission, the power of corresponding REs may also be used for the scheduled DMRS transmission. Therefore, the power boosting needs to be enhanced.

Similarly, power boosting for PTRS transmission also needs to be enhanced. In Release 15, for single-symbol DMRS, only up to 6 DMRS ports can be supported; for double-symbol DMRS, only up to 12 DMRS ports can be supported. In Release 18, with the introduction of additional DMRS ports, single-symbol DMRS can support up to 8 and 12 DMRS ports for DMRS type 1 and DMRS type 2, respectively; and double-symbol DMRS can support up to 16 and 24 DMRS ports for DMRS type 1 and DMRS type 2, respectively.

Since UE is not expected to be scheduled with DMRS with TD-OCC and PTRS in the same slot, the power boosting of PTRS is only supported for up to six-layer PDSCH transmission in Release 15. Since the maximum layers of a PDSCH transmission is 8 layers, PTRS power boosting should be enhanced to support up to 8-layer PDSCH transmission. For PTRS of PUSCH transmission, Release 15 UL PTRS power boosting is supported for only up to 4-layer PUSCH transmission since the maximum layers of a PUSCH transmission is 4. In Release 18, there is a need to enable 8 Tx UL operation to support 4 and more layers transmission. Therefore, with the increased number of DMRS ports and more layers of a PUSCH transmission, PTRS power boosting may be enhanced to support up to 8-layer PUSCH transmission.

In the disclosure, methods of power boosting for DMRS and PTRS are proposed when a UE supports the increased number of DMRS ports.

### DMRS Power Boosting

In Release 18 MIMO, FDM may be used to increase the number of DMRS ports without increasing the DM-RS overhead. In Release 15, 16 and 17 of 3GPP specifications, up to 8 orthogonal DMRS ports (e.g., DMRS ports 0-7) are supported for DMRS type 1, and up to 12 orthogonal DMRS ports (e.g., DMRS ports 0-11) are supported for DMRS type 2.

In Release 18, up to 16 and 24 DMRS ports may be supported for DMRS type 1 and DMRS type 2, respectively, i.e., the legacy DMRS ports 0-7 and the newly introduced additional DMRS ports 8-15 for DMRS type 1, and the legacy DMRS ports 0-11 and the newly introduced additional DMRS ports 12-23 for DMRS type 2. Type 1 DMRS ports 0-7 or type 2 DMRS ports 0-11 may also be referred to as the first set of DMRS ports. Type 1 DMRS ports 8-15 or type 2 DMRS ports 12-23 may also be referred to as the second set of DMRS ports.

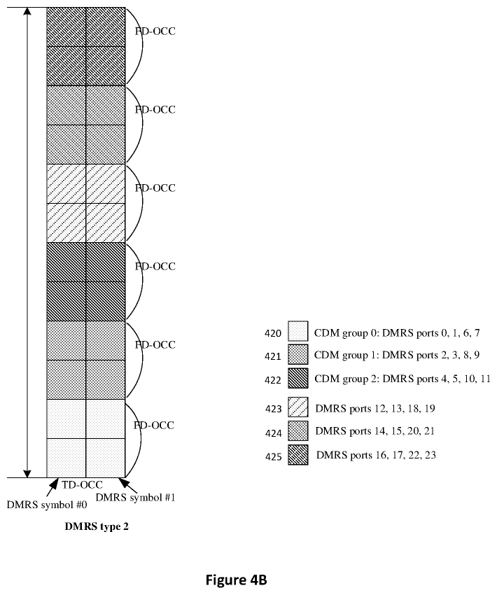

FIGS. 4A and 4B are schematic diagrams illustrating examples of DMRS ports increased in number by FDM manner for DMRS type 1 and DMRS type 2, respectively. As shown in FIGS. 4A and 4B, the additional DMRS ports (e.g., DMRS ports 8-15 in FIG. 4A, and DMRS ports 11-23 in FIG. 4B) are achieved by FDM manner and the number of REs occupied by each DMRS port is halved, compared to DMRS in Release 15.

The additional DMRS ports and the legacy DMRS ports are mapped to different REs. The legacy DMRS ports are DMRS ports mapped to the REs in solid shade (e.g., 410, 411, 420, 421, 422), i.e., from DMRS port 0 to DMRS port 7 for DMRS type 1 and from DMRS port 0 to DMRS port 11 for DMRS type 2. The additional DMRS ports are DMRS ports mapped to the REs with line patterns (e.g., 412, 413, 423, 424, 425), i.e., from DMRS port 8 to DMRS port 15 for DMRS type 1 and from DMRS port 12 to DMRS port 23 for DMRS type 2. If the scheduled DMRS port(s) of a PDSCH or a PUSCH transmission is all legacy DMRS ports, and the REs with line patterns are not used for transmission of data, the power of REs with line patterns can be used to boost the transmit power of the scheduled DMRS to improve the performance of the scheduled DMRS.

In a first scenario, no new CDM group is introduced with the introduction of additional DMRS ports.

No new CDM group is introduced, that is, DMRS type 1 includes two CDM groups and DMRS type 2 includes three CDM groups, the same as in Release 16, while the DMRS ports within a same CDM group is doubled. As shown in FIGS. 4A and 4B, DMRS ports mapped to the REs of the same grey level are within one CDM group. That is, DMRS ports mapped to REs 410 and 412 are of the same CDM group; and DMRS ports mapped to REs 411 and 413, DMRS ports mapped to REs 420 and 423, DMRS ports mapped to REs 421 and 424, and DMRS ports mapped to REs 422 and 425 are of the same CDM group, respectively. The mapping between DMRS ports and CDM groups is provided in Table 1 below.

TABLE 1
Mapping between DMRS ports and CDM groups
without introducing new CDM group

| | CDM | |
|---|---|---|
| DMRS type | group λ | DMRS port index |
| DMRS type 1 | 0 | 0, 1, 4, 5, 8, 9, 12, 13 |
| | 1 | 2, 3, 6, 7, 10, 11, 14, 15 |
| DMRS type 2 | 0 | 0, 1, 6, 7, 12, 13, 18, 19 |
| | 1 | 2, 3, 8, 9, 14, 15, 20, 21 |
| | 2 | 4, 5, 10, 11, 16, 17, 22, 23 |

In this case, if the scheduled DMRS ports are in a first half of DMRS ports in a CDM group, and a second half of DMRS ports are not used for data transmission, the power of REs corresponding to the second half of DMRS ports may be used to boost the scheduled DMRS transmission. DMRS ports within each CDM group include two subgroups of DMRS ports occupying different REs. The first half of DMRS ports in a CDM group (e.g. DMRS ports 0, 1, 4, and 5) may also be referred to as the first subgroup of DMRS ports; and the second half of DMRS ports in the CDM group (e.g. DMRS ports 8, 9, 12, and 13) may also be referred to as the second subgroup of DMRS ports. A flag may be introduced to indicate whether the other half of DMRS ports (e.g., the second subgroup of DMRS ports in the CDM group), other than the first half of DMRS ports (e.g., the first subgroup of DMRS ports in the CDM group) which include the scheduled DMRS ports within a CDM group, may be used for power boosting or not. Specifically, if the indicated DMRS port is only among the first half of DMRS ports (e.g., the DMRS ports not in bold in Table 1), the flags indicate whether the other half of DMRS ports (e.g., the DMRS ports in bold in Table 1) may be used for power boosting. Similarly, if the indicated DMRS port is only among the second half of DMRS ports (e.g., the DMRS ports in bold in Table 1), the flags indicate whether the other half of DMRS ports (e.g., the DMRS ports not in bold in Table 1) may be used for power boosting. The flag is CDM group specific and it may be indicated in the scheduled DCI. That is, there are two flags and three flags for DMRS type 1 and type 2, respectively. If the flag for the CDM group is not configured or disabled, indicated as “0” for example, the power of the other half of DMRS ports is not allowed to be borrowed for the scheduled DMRS transmission; and if the flag is enabled, indicated as “1” for example, the power of the other half of DMRS ports is allowed to be used for power boosting. In some other examples, the flag of value “0” may indicate enabled, while the flag of value “1” may indicate disabled.

The ratio of PDSCH EPRE to DM-RS EPRE is calculated by −10*log₁₀ (number of DMRS CDM groups without data+number of enabled flags), where enabled flag means the flag of a CDM group that is enabled to indicate that a subgroup of DMRS ports in the CDM group is used for power boosting, and the detailed values of the ratios are provided in Table 2. Alternatively, the ratio of PDSCH EPRE to DM-RS EPRE may also be represented as:

$$- 10 * {log}_{10} ( G + F )$$

where G represents number of DMRS CDM groups without data, and F represents number of flags indicating that power boosting using a subgroup of DMRS ports is enabled. If the scheduled DMRS ports are in both the first half and second half of DMRS ports of a CDM group, which means the DMRS ports are mapped to REs with both solid shade and line patterns of the same grey level as shown in FIGS. 4A and 4B, the corresponding flag for the CDM group is indicated as disabled.

For DMRS type 1, up to two CDM groups are supported, and the number of enabled flags may be 0, 1 or 2; and for DMRS type 2, up to three CDM groups are supported, and the number of enabled flags may be 0, 1, 2 or 3. If the number of enabled flags is 1, for DMRS type 1, the ratio is −3 dB and −4.77 dB when number of CDM groups without data is 1 and 2, respectively; and for DMRS type 2, the ratio is −3 dB, −4.77 dB, and −6 dB when number of CDM groups without data is 1, 2, and 3, respectively. If the number enabled flags is 2, the ratio is −6 dB for DMRS type 1 when number of CDM groups without data is 2; and for DMRS type 2, the ratio is-6 dB and −7 dB when number of CDM groups without data is 2 and 3, respectively. If the number enabled flags is 3, the ratio is −7.78 dB for DMRS type 2 when number of CDM groups without data is 3.

TABLE 2
Ratio of PDSCH EPRE to DM-RS EPRE

| Number of DM- | The number | DM-RS | | DM-RS | |
|---|---|---|---|---|---|
| RS CDM groups | of enabled | configuration | | configuration | |
| without data | flags | type 1 | | type 2 | |
| 1 | 0 | 0 | dB | 0 | dB |
| | 1 | −3 | dB | −3 | dB |
| 2 | 0 | −3 | dB | −3 | dB |
| | 1 | −4.77 | dB | −4.77 | dB |
| | 2 | −6 | dB | −6 | dB |

| | | | | |
|---|---|---|---|---|
| 3 | 0 | — | −4.77 | dB |
| | 1 | — | −6 | dB |
| | 2 | — | −7 | dB |
| | 3 | — | −7.78 | dB |

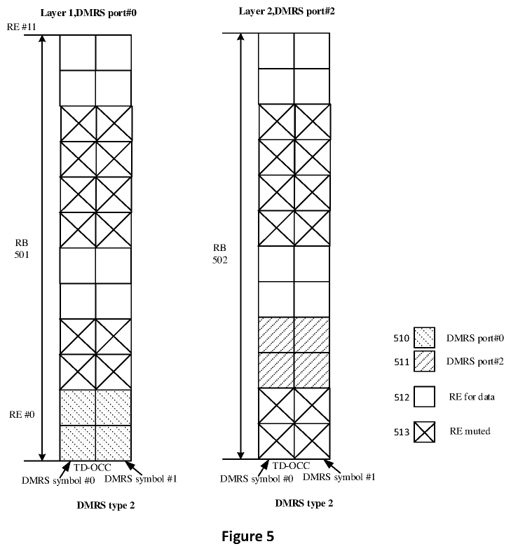

FIG. 5 is a schematic diagram illustrating an example of power boosting by unused REs of additional DMRS ports for DMR type 2 in accordance with some implementations of the present disclosure. In the example, suppose a DCI format 1_1 schedules a PDSCH transmission and the DMRS is type 2 (as shown in FIG. 4B), and suppose the DMRS ports indicated in the DCI are DMRS port 0 in CDM group 0 and DMRS port 2 in CDM group 1. As shown in FIG. 5, while the RB 501 of Layer 1 and RB 502 of Layer 2 are the same in frequency domain, they may also be considered different RBs as they are in different layers. REs of DMRS port #0 510 in Layer 1 and REs of DMRS port #1 511 in Layer 2 are for DMRS transmission. To ensure the orthogonality between DMRS and data on different layers for one UE, some REs 513 (marked with “X”) are unavailable for mapping data for one layer of the PDSCH transmission, i.e., REs corresponding to DMRS port 0 on layer 2 and REs corresponding to DMRS port 2 on layer 1 are muted. The REs 512 may be available for transmission of data. Suppose the other CDM group (i.e., CDM group 2) is used for transmission of data or other purpose, then the number of DMRS CDM group without data is 2. The second half of DMRS ports in CDM group 0 and CDM group 1 are not used for the PDSCH transmission, and then the corresponding REs will not be used for either DMRS transmission or data transmission. In the case where the flags for CDM group 0 and CDM group 1 are both enabled, the power of unused REs (REs corresponding to the second half of DMRS ports) can be used to boost the transmit power of the DMRS corresponding to this particular layer; and the number of enabled flags is two, and the ratio of PDSCH EPRE to DM-RS EPRE is −6 dB.

In a second scenario, new CDM groups are introduced. New CDM groups are introduced for the additional DMRS ports such that DMRS type 1 includes four CDM groups and DMRS type 2 includes six CDM groups. DMRS ports mapped to the REs of same grey level but with different patterns as shown in FIGS. 4A and 4B are denoted as among different CDM groups. That is, for DMRS type 1, as shown in FIG. 4A, DMRS ports 0, 1, 4, 5 mapped to the REs 410 constitute a CDM group 0, the same as in Release 15, and DMRS ports 8, 9, 12, 13 mapped to the REs 412 constitute another CDM, for example CDM group 2. Similarly, DMRS ports 2, 5, 6, 7 mapped to the REs 411 constitute a CDM group 1 as in Release 15, and DMRS ports 10, 11, 14, 15 mapped to the REs 413 constitute another CDM, for example CDM group 3. The same rule is applied for DMRS type 2. That is, CDM group 3, CDM group 4 and CDM group 5 are introduced for DMRS type 2. CDM group 3 includes the additional DMRS ports 12, 13, 18, 19 mapped to REs 423; CDM group 4 includes the additional DMRS ports 14, 15, 20, 21 mapped to REs 424; and CDM group 5 includes the additional DMRS ports 16, 17, 22, 23 mapped to REs 425 as shown in FIG. 4B. The mapping between DMRS ports and CDM groups is provided in Table 3 below.

TABLE 3
Mapping between DMRS ports and
CDM groups with new CDM groups

| | CDM | |
|---|---|---|
| DMRS type | group λ | DMRS port index |
| DMRS type | 0 | 0, 1, 4, 5 |
| 1 | 1 | 2, 3, 6, 7 |
| | 2 | 8, 9, 12, 13 |
| | 3 | 10, 11, 14, 15 |
| DMRS type | 0 | 0, 1, 6, 7 |
| 2 | 1 | 2, 3, 8, 9 |
| | 2 | 4, 5, 10, 11 |
| | 3 | 12, 13, 18, 19 |
| | 4 | 14, 15, 20, 21 |
| | 5 | 16, 17, 22, 23 |

The ratio of PDSCH EPRE to DM-RS EPRE needs to be enhanced as shown in Table 4 to support the case of more than three CDM groups. The CDM groups, where the number of CDM groups without data is 4, 5, and 6, may be CDM groups {0,1,2,3}, {0,1,2,3,4}, and {0,1,2,3,4,5}, respectively. For DMRS type 1, up to four CDM groups are supported; and for DMRS type 2, up to six CDM groups are supported. For DMRS type 1, the ratio is −4.77 dB and −6 dB when number of CDM groups without data is 3 and 4, respectively; and for DMRS type 2, the ratio is −6 dB, −7 dB, and −7.78 dB when number of CDM groups without data is 4, 5, and 6, respectively.

TABLE 4
Ratio of PDSCH EPRE to DM-RS EPRE

| Number of DM-RS CDM | DM-RS configuration | | DM-RS configuration | |
|---|---|---|---|---|
| groups without data | type 1 | | type 2 | |
| 1 | 0 | dB | 0 | dB |
| 2 | −3 | dB | −3 | dB |
| 3 | −4.77 | dB | −4.77 | dB |
| 4 | −6 | dB | −6 | dB |

| | | | |
|---|---|---|---|
| 5 | — | −7 | dB |
| 6 | — | −7.78 | dB |

In one example, suppose a DCI format 0_1 schedules a PUSCH transmission, and the DMRS configuration is type 1. The DMRS ports are illustrated as show in FIG. 4A. Suppose the DMRS ports indicated in the DCI are DMRS port 0 to DMRS port 7, then two CDM groups (i.e., CDM group 0 and CDM group 1) are used. If the other CDM groups (i.e., CDM group 3 and CDM group 4) are not used for transmission of data, that is, the number of DMRS CDM groups without data indicated in the DCI is 4, the ratio of PDSCH EPRE to DM-RS EPRE is −6 dB.

### PTRS Power Boosting

Similar to power boosting of DMRS, power boosting of PTRS also needs to be enhanced due to the increased number of DMRS ports. Since the PTRS and data are orthogonal, some REs on different layers from the PTRS but with the same locations as PTRS are unavailable for data transmission. Then the power of these unavailable REs can be used to boost the PTRS transmission.

In Release 15, single-symbol DMRS supports only up to 6 DMRS ports (i.e., 6-layer transmission) and double-symbol DMRS supports up to 12 DMRS ports. The power boosting of PTRS is only supported for up to 6-layer PDSCH transmission since when PTRS is transmitted, UE is not expected to be scheduled with DMRS with TD-OCC.

In Release 18, with the increased number of DMRS ports, single-symbol DMRS can support up to 8 and 12 DMRS ports for DMRS type 1 and DMRS type 2, respectively. Since the maximum number of layers of a PDSCH transmission is 8, PTRS power boosting should be enhanced to support up to 8-layer PDSCH transmission. The UE may be configured with a configuration of Phase-Tracking Reference Signal (PTRS) for a data transmission. The data transmission may be a Physical Downlink Shared Channel (PDSCH) transmission with more than six layers, or a Physical Uplink Shared Channel (PUSCH) transmission with more than four layers. The PTRS transmission and DMRS transmission with Time Division Orthogonal Cover Code (TD-OCC) are not occurring simultaneously. The ratio of PTRS EPRE to PDSCH EPRE can be found in Table 5 with the increased number of DMRS ports. For example, for a PDSCH transmission with seven layers, the ratio is 8.5 dB; and for a PDSCH transmission with eight layers, the ratio is 9 dB.

TABLE 5
Ratio of PTRS EPRE to PDSCH EPRE per layer per RE (ρ_{PTRS})

| | The number of PDSCH layers with DM-RS associated to the PT-RS port | | | | | | | |
|---|---|---|---|---|---|---|---|---|
| epre-Ratio | 1 | 2 | 3 | 4 | 5 | 6 | 7 | 8 |
| 0 | 0 | 3 | 4.77 | 6 | 7 | 7.78 | 8.5 | 9 |
| 1 | 0 | 0 | 0 | 0 | 0 | 0 | 0 | 0 |

| | |
|---|---|
| 2 | reserved |
| 3 | reserved |

In one example, suppose a DCI format 1_2 schedules a PDSCH transmission, and the DMRS configuration is type 1. The DMRS ports are illustrated as shown in FIG. 4A. Suppose the number of PTRS port is one and the DMRS ports indicated in the DCI are DMRS port 0 to DMRS port 7. If the epre-Ratio is configured as 0, according to Table 5, the ratio of PT-RS EPRE to PDSCH EPRE per layer per RE is 9 dB.

The same issue exists for PTRS of PUSCH transmission. Release 15 also supports power boosting for UL PTRS transmission, but UL PTRS power boosting supports only up to 4-layer PUSCH transmission since the maximum number of layers of a PUSCH transmission is 4.

In Release 18, eight TX UL operation may be enabled to support four and more layers transmission. Then, UL PTRS power boosting should be enhanced to support up to 8-layer PUSCH transmission. The EPRE ratio of PUSCH to PTRS is provided in Table 6 for the four and more layers PUSCH transmission, where Op is the number of PTRS ports of the PUSCH transmission. The UE may further receive a configuration parameter for configuring a power boosting factor for each PTRS port of the PUSCH transmission. For example, for the configuration parameter with value “00”, the power boosting factor is 7 dB, 7.78 dB, 8.5 dB and 9 dB for 5-layer, 6-layer, 7-layer and 8-layer full coherent codebook based PUSCH transmission, respectively; the power boosting factor is 3 Qp dB, 4.77 Qp dB, 4.77 Qp dB and 6 Qp dB for 5-layer, 6-layer, 7-layer and 8-layer partial coherent codebook based PUSCH transmission, respectively; and the power boosting factor is 3 Qp-3 dB for a more than 4-layer non-coherent codebook based PUSCH transmission or non-codebook based PUSCH transmission; where Qp is the number of PTRS ports of the PUSCH transmission. For the configuration parameter with value “01”, the power boosting factor is 7 dB, 7.78 dB, 8.5 dB and 9 dB for 5-layer, 6-layer, 7-layer and 8-layer PUSCH transmission, respectively.

TABLE 6
Factor related to PUSCH to PT-RS power ratio per layer per RE α_{PTRS}^{PUSCH} for more than 4 layers PUSCH transmission

| | The number of PUSCH layers (n_{layer}^{PUSCH}) | | | | | | | | | | | |
|---|---|---|---|---|---|---|---|---|---|---|---|---|
| | 5 | | | | | | | | | 8 | | |
| | | | Non- | | | non- | | | non- | | | Non- |
| UL | | | coherent | 6 | | coherent | 7 | | coherent | | | coherent |
| PTRS | Full | Partial | and non- | Full | Partial | and non- | Full | Partial | and non- | Full | Partial | and non- |
| power/ | coher- | coher- | codebook | coher- | coher- | codebook | coher- | coher- | codebook | coher- | coher- | codebook |
| α_{PTRS}^{PUSCH} | ent | ent | based | ent | ent | based | ent | ent | based | ent | ent | based |
| 00 | 7 | 3Qₚ | 3Qₚ-3 | 7.78 | 4.77Qₚ | 3Qₚ-3 | 8.5 | 4.77Qₚ | 3Qₚ-3 | 9 | 6Qₚ | 3Qₚ-3 |
| 01 | 7 | 7 | 7 | 7.78 | 7.78 | 7.78 | 8.5 | 8.5 | 8.5 | 9 | 9 | 9 |

| | |
|---|---|
| 10 | Reserved |
| 11 | Reserved |

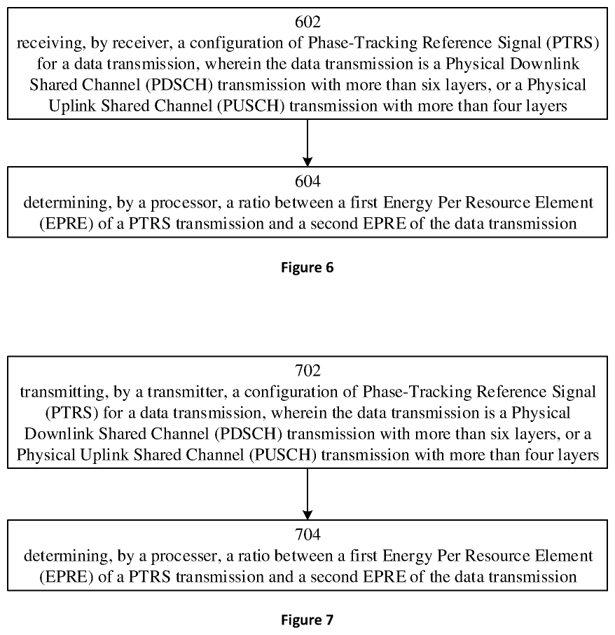

FIG. 6 is a flow chart illustrating steps of power boosting for PTRS by UE 200 in accordance with some implementations of the present disclosure.

At step 602, the receiver 214 of UE 200 receives a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers.

At step 604, the processor 202 of UE 200 determines a ratio between a first Energy Per Resource Element (EPRE) of a PTRS transmission and a second EPRE of the data transmission.

FIG. 7 is a flow chart illustrating steps of power boosting for PTRS by gNB 300 in accordance with some implementations of the present disclosure.

At step 702, the transmitter 312 of gNB 200 transmits a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers.

At step 704, the processor 302 of gNB 300 determines a ratio between a first Energy Per Resource Element (EPRE) of a PTRS transmission and a second EPRE of the data transmission.

In one aspect, some items as examples of the disclosure concerning UE may be summarized as follows:

1. An apparatus, comprising:
a receiver that receives a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers;
a processor that determines a ratio between a first Energy Per Resource Element (EPRE) of a PTRS transmission and a second EPRE of the data transmission.

2. The apparatus of item 1, wherein the PTRS transmission and Demodulation Reference Signal (DMRS) transmission with Time Division Orthogonal Cover Code (TD-OCC) are not occurring simultaneously.

3. The apparatus of item 1, wherein for a PDSCH transmission with seven layers, the ratio is 8.5 dB; and for a PDSCH transmission with eight layers, the ratio is 9 dB.

4. The apparatus of item 1, wherein the receiver further receives a configuration parameter for configuring a power boosting factor for each PTRS port of the PUSCH transmission.

5. The apparatus of item 4, wherein for the configuration parameter with value “00”, the power boosting factor is 7 dB, 7.78 dB, 8.5 dB and 9 dB for 5-layer, 6-layer, 7-layer and 8-layer full coherent codebook based PUSCH transmission, respectively; the power boosting factor is 3 Qp dB, 4.77 Qp dB, 4.77 Qp dB and 6 Qp dB for 5-layer, 6-layer, 7-layer and 8-layer partial coherent codebook based PUSCH transmission, respectively; and the power boosting factor is 3 Qp-3 dB for a more than 4-layer non-coherent codebook based PUSCH transmission or non-codebook based PUSCH transmission; where Qp is the number of PTRS ports of the PUSCH transmission.

6. The apparatus of item 4, wherein for the configuration parameter with value “01”, the power boosting factor is 7 dB, 7.78 dB, 8.5 dB and 9 dB for 5-layer, 6-layer, 7-layer and 8-layer PUSCH transmission, respectively.

7. The apparatus of item 1, wherein the receiver further receives a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; and the processor further determines a second ratio between the second EPRE of the data transmission and a third EPRE of DMRS transmission.

8. The apparatus of item 7, wherein for DMRS type 1, up to two CDM groups are supported; and for DMRS type 2, up to three CDM groups are supported; and DMRS ports within each CDM group include two subgroups of DMRS ports occupying different REs; and the receiver further receives a flag for each CDM group indicating whether using a second subgroup of DMRS ports in the CDM group for power boosting of a scheduled DMRS transmission in DMRS ports of a first subgroup is enabled or not.

9. The apparatus of item 8, wherein the flag is indicated in a DCI, with a first value indicating that power boosting using the second subgroup of DMRS ports is disabled, and with a second value indicating that power boosting using the second subgroup of DMRS ports is enabled.

10. The apparatus of item 9, wherein the second ratio is determined by:

−10*log₁₀(G+F)

where G represents number of DMRS CDM groups without data, and F represents number of flags indicating that power boosting using the second subgroup of DMRS ports is enabled.

11. The apparatus of item 7, wherein, for DMRS type 1, up to four CDM groups are supported; and for DMRS type 2, up to six CDM groups are supported.

12. The apparatus of item 11, wherein, for DMRS type 1, the second ratio is-4.77 dB and −6 dB when number of CDM groups without data is 3 and 4, respectively; and for DMRS type 2, the second ratio is −6 dB, −7 dB, and −7.78 dB when number of CDM groups without data is 4, 5, and 6, respectively.

13. The apparatus of item 12, wherein CDM groups, where the number of CDM groups without data is 4, 5, and 6, are CDM groups {0,1,2,3}, {0,1,2,3,4}, and {0,1,2,3,4,5}, respectively.

In another aspect, some items as examples of the disclosure concerning gNB may be summarized as follows:

14. An apparatus, comprising:
a transmitter that transmits a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers;
a processor that determines a ratio between a first Energy Per Resource Element (EPRE) of a PTRS transmission and a second EPRE of the data transmission.

15. The apparatus of item 14, wherein the PTRS transmission and Demodulation Reference Signal (DMRS) transmission with Time Division Orthogonal Cover Code (TD-OCC) are not occurring simultaneously.

16. The apparatus of item 14, wherein for a PDSCH transmission with seven layers, the ratio is 8.5 dB; and for a PDSCH transmission with eight layers, the ratio is 9 dB.

17. The apparatus of item 14, wherein the transmitter further transmits a configuration parameter for configuring a power boosting factor for each PTRS port of the PUSCH transmission.

18. The apparatus of item 17, wherein the configuration parameter with value “00” indicates that: the power boosting factor is 7 dB, 7.78 dB, 8.5 dB and 9 dB for 5-layer, 6-layer, 7-layer and 8-layer full coherent codebook based PUSCH transmission, respectively; the power boosting factor is 3 Qp dB, 4.77 Qp dB, 4.77 Qp dB and 6 Qp dB for 5-layer, 6-layer, 7-layer and 8-layer partial coherent codebook based PUSCH transmission, respectively; and the power boosting factor is 3 Qp-3 dB for a more than 4-layer non-coherent codebook based PUSCH transmission or non-codebook based PUSCH transmission; where Qp is the number of PTRS ports of the PUSCH transmission.

19. The apparatus of item 17, wherein the configuration parameter with value “01” indicates that the power boosting factor is 7 dB, 7.78 dB, 8.5 dB and 9 dB for 5-layer, 6-layer, 7-layer and 8-layer PUSCH transmission, respectively.

20. The apparatus of item 14, wherein the transmitter further transmits a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; and the processor further determines a second ratio between the second EPRE of the data transmission and a third EPRE of DMRS transmission.

21. The apparatus of item 20, wherein for DMRS type 1, up to two CDM groups are supported; and for DMRS type 2, up to three CDM groups are supported; and DMRS ports within each CDM group include two subgroups of DMRS ports occupying different REs; and the transmitter further transmits a flag for each CDM group indicating whether using a second subgroup of DMRS ports in the CDM group for power boosting of a scheduled DMRS transmission in DMRS ports of a first subgroup is enabled or not.

22. The apparatus of item 21, wherein the flag is indicated in a DCI, with a first value indicating that power boosting using the second subgroup of DMRS ports is disabled, and with a second value indicating that power boosting using the second subgroup of DMRS ports is enabled.

23. The apparatus of item 22, wherein the second ratio is determined by:

$$- 10 * {log}_{10} ( G + F )$$

where G represents number of DMRS CDM groups without data, and F represents number of flags indicating that power boosting using the second subgroup of DMRS ports is enabled.

24. The apparatus of item 20, wherein, for DMRS type 1, up to four CDM groups are supported; and for DMRS type 2, up to six CDM groups are supported.

25. The apparatus of item 24, wherein, for DMRS type 1, the second ratio is-4.77 dB and −6 dB when number of CDM groups without data is 3 and 4, respectively; and for DMRS type 2, the second ratio is −6 dB, −7 dB, and −7.78 dB when number of CDM groups without data is 4, 5, and 6, respectively.

26. The apparatus of item 25, wherein CDM groups, where the number of CDM groups without data is 4, 5, and 6, are CDM groups {0,1,2,3}, {0,1,2,3,4}, and {0,1,2,3,4,5}, respectively.

In a further aspect, some items as examples of the disclosure concerning a method of UE may be summarized as follows:

27. A method, comprising:
receiving, by receiver, a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers;
determining, by a processor, a ratio between a first Energy Per Resource Element (EPRE) of a PTRS transmission and a second EPRE of the data transmission.

28. The method of item 27, wherein the PTRS transmission and Demodulation Reference Signal (DMRS) transmission with Time Division Orthogonal Cover Code (TD-OCC) are not occurring simultaneously.

29. The method of item 27, wherein for a PDSCH transmission with seven layers, the ratio is 8.5 dB; and for a PDSCH transmission with eight layers, the ratio is 9 dB.

30. The method of item 27, wherein the receiver further receives a configuration parameter for configuring a power boosting factor for each PTRS port of the PUSCH transmission.

31. The method of item 30, wherein for the configuration parameter with value “00”, the power boosting factor is 7 dB, 7.78 dB, 8.5 dB and 9 dB for 5-layer, 6-layer, 7-layer and 8-layer full coherent codebook based PUSCH transmission, respectively; the power boosting factor is 3 Qp dB, 4.77 Qp dB, 4.77 Qp dB and 6 Qp dB for 5-layer, 6-layer, 7-layer and 8-layer partial coherent codebook based PUSCH transmission, respectively; and the power boosting factor is 3 Qp-3 dB for a more than 4-layer non-coherent codebook based PUSCH transmission or non-codebook based PUSCH transmission; where Qp is the number of PTRS ports of the PUSCH transmission.

32. The method of item 30, wherein for the configuration parameter with value “01”, the power boosting factor is 7 dB, 7.78 dB, 8.5 dB and 9 dB for 5-layer, 6-layer, 7-layer and 8-layer PUSCH transmission, respectively.

33. The method of item 27, wherein the receiver further receives a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; and the processor further determines a second ratio between the second EPRE of the data transmission and a third EPRE of DMRS transmission.

34. The method of item 33, wherein for DMRS type 1, up to two CDM groups are supported; and for DMRS type 2, up to three CDM groups are supported; and DMRS ports within each CDM group include two subgroups of DMRS ports occupying different REs; and the receiver further receives a flag for each CDM group indicating whether using a second subgroup of DMRS ports in the CDM group for power boosting of a scheduled DMRS transmission in DMRS ports of a first subgroup is enabled or not.

35. The method of item 34, wherein the flag is indicated in a DCI, with a first value indicating that power boosting using the second subgroup of DMRS ports is disabled, and with a second value indicating that power boosting using the second subgroup of DMRS ports is enabled.

36. The method of item 35, wherein the second ratio is determined by:

$$- 10 * {log}_{10} ( G + F )$$

where G represents number of DMRS CDM groups without data, and F represents number of flags indicating that power boosting using the second subgroup of DMRS ports is enabled.

37. The method of item 33, wherein, for DMRS type 1, up to four CDM groups are supported; and for DMRS type 2, up to six CDM groups are supported.

38. The method of item 37, wherein, for DMRS type 1, the second ratio is-4.77 dB and −6 dB when number of CDM groups without data is 3 and 4, respectively; and for DMRS type 2, the second ratio is −6 dB, −7 dB, and −7.78 dB when number of CDM groups without data is 4, 5, and 6, respectively.

39. The method of item 38, wherein CDM groups, where the number of CDM groups without data is 4, 5, and 6, are CDM groups {0,1,2,3}, {0,1,2,3,4}, and {0,1,2,3,4,5}, respectively.

In a yet further aspect, some items as examples of the disclosure concerning a method of gNB may be summarized as follows:

40. A method, comprising:
transmitting, by a transmitter, a configuration of Phase-Tracking Reference Signal (PTRS) for a data transmission, wherein the data transmission is a Physical Downlink Shared Channel (PDSCH) transmission with more than six layers, or a Physical Uplink Shared Channel (PUSCH) transmission with more than four layers;
determining, by a processer, a ratio between a first Energy Per Resource Element (EPRE) of a PTRS transmission and a second EPRE of the data transmission.

41. The method of item 40, wherein the PTRS transmission and Demodulation Reference Signal (DMRS) transmission with Time Division Orthogonal Cover Code (TD-OCC) are not occurring simultaneously.

42. The method of item 40, wherein for a PDSCH transmission with seven layers, the ratio is 8.5 dB; and for a PDSCH transmission with eight layers, the ratio is 9 dB.

43. The method of item 40, wherein the transmitter further transmits a configuration parameter for configuring a power boosting factor for each PTRS port of the PUSCH transmission.

44. The method of item 43, wherein the configuration parameter with value “00” indicates that: the power boosting factor is 7 dB, 7.78 dB, 8.5 dB and 9 dB for 5-layer, 6-layer, 7-layer and 8-layer full coherent codebook based PUSCH transmission, respectively; the power boosting factor is 3 Qp dB, 4.77 Qp dB, 4.77 Qp dB and 6 Qp dB for 5-layer, 6-layer, 7-layer and 8-layer partial coherent codebook based PUSCH transmission, respectively; and the power boosting factor is 3 Qp-3 dB for a more than 4-layer non-coherent codebook based PUSCH transmission or non-codebook based PUSCH transmission; where Qp is the number of PTRS ports of the PUSCH transmission.

45. The method of item 43, wherein the configuration parameter with value “01” indicates that the power boosting factor is 7 dB, 7.78 dB, 8.5 dB and 9 dB for 5-layer, 6-layer, 7-layer and 8-layer PUSCH transmission, respectively.

46. The method of item 40, wherein the transmitter further transmits a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; and the processor further determines a second ratio between the second EPRE of the data transmission and a third EPRE of DMRS transmission.

47. The method of item 46, wherein for DMRS type 1, up to two CDM groups are supported; and for DMRS type 2, up to three CDM groups are supported; and DMRS ports within each CDM group include two subgroups of DMRS ports occupying different REs; and the transmitter further transmits a flag for each CDM group indicating whether using a second subgroup of DMRS ports in the CDM group for power boosting of a scheduled DMRS transmission in DMRS ports of a first subgroup is enabled or not.

48. The method of item 47, wherein the flag is indicated in a DCI, with a first value indicating that power boosting using the second subgroup of DMRS ports is disabled, and with a second value indicating that power boosting using the second subgroup of DMRS ports is enabled.

49. The method of item 48, wherein the second ratio is determined by:

$$- 10 * {log}_{10} ( G + F )$$

where G represents number of DMRS CDM groups without data, and F represents number of flags indicating that power boosting using the second subgroup of DMRS ports is enabled.

50. The method of item 46, wherein, for DMRS type 1, up to four CDM groups are supported; and for DMRS type 2, up to six CDM groups are supported.

51. The method of item 50, wherein, for DMRS type 1, the second ratio is-4.77 dB and −6 dB when number of CDM groups without data is 3 and 4, respectively; and for DMRS type 2, the second ratio is −6 dB, −7 dB, and −7.78 dB when number of CDM groups without data is 4, 5, and 6, respectively.

52. The method of item 51, wherein CDM groups, where the number of CDM groups without data is 4, 5, and 6, are CDM groups {0,1,2,3}, {0,1,2,3,4}, and {0,1,2,3,4,5}, respectively.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a configuration of Phase-Tracking Reference Signal (PTRS) and configuration of Rel-18 Demodulation Reference Signal (DMRS) for a data transmission, wherein the data transmission is a Physical Downlink Shared Channel (PDSCH) transmission with more than six layers, or a Physical Uplink Shared Channel (PUSCH) transmission with more than four layers;
determine a ratio between an Energy Per Resource Element (EPRE) of a PTRS transmission and an EPRE of the data PDSCH transmission; and
determine a PUSCH to PTRS power ratio of the PUSCH transmission.

2. The UE of claim 1, wherein the PTRS transmission and DMRS transmission with Time Division Orthogonal Cover Code (TD-OCC) are not occurring simultaneously.

3. The UE of claim 1, wherein for a number of layers of a PDSCH transmission with DMRS associated with a PTRS port with eight layers, an EPRE ratio is 9 dB if an epre-Ratio is ‘00’.

4. (canceled)

5. The UE of claim 1, wherein for a value of a parameter for configuring a power boosting factor for each PTRS port of the PUSCH transmission being “00”, the PUSCH to PTRS power ratio is 7 dB, 7.78 dB, and 9 dB for 5-layer, 6-layer, and 8-layer full coherent codebook based PUSCH transmission, respectively.

6. The UE of claim 1, wherein for a value of a parameter for configuring a power boosting factor for each PTRS port of the PUSCH transmission being “01”, the PUSCH to PTRS power ratio is 7 dB, 7.78 dB, and 9 dB for 5-layer, 6-layer, and 8-layer PUSCH transmission, respectively.

7. The UE of claim 1, wherein the at least one processor is configured to cause the UE to receive a configuration for Demodulation Reference Signal (DMRS) that includes a first set of DMRS ports and a second set of DMRS ports, wherein the first set of DMRS ports comprises type 1 DMRS ports 0-7 or type 2 DMRS ports 0-11; and the second set of DMRS ports comprises type 1 DMRS ports 8-15 or type 2 DMRS ports 12-23; and the processor further determines a second ratio between the EPRE of the data transmission and a third EPRE of DMRS transmission.

8. The UE of claim 7, wherein for DMRS type 1, up to two CDM groups are supported; and for DMRS type 2, up to three CDM groups are supported; and DMRS ports within each CDM group include two subgroups of DMRS ports occupying different REs; and the receiver further receives a flag for each CDM group indicating whether using a second subgroup of DMRS ports in the CDM group for power boosting of a scheduled DMRS transmission in DMRS ports of a first subgroup is enabled or not.

9. The UE of claim 8, wherein the flag is indicated in a DCI, with a first value indicating that power boosting using the second subgroup of DMRS ports is disabled, and with a second value indicating that power boosting using the second subgroup of DMRS ports is enabled.

10. The UE of claim 9, wherein the second ratio is determined by:
−10*log₁₀ (G+F)ere G represents number of DMRS CDM groups without data, and F represents number of flags indicating that power boosting using the second subgroup of DMRS ports is enabled.

11. The UE of claim 7, wherein, for DMRS type 1, up to four CDM groups are supported; and for DMRS type 2, up to six CDM groups are supported.

12. The UE of claim 11, wherein, for DMRS type 1, a second ratio is −4.77 dB and −6 dB when number of CDM groups without data is 3 and 4, respectively; and for DMRS type 2, the second ratio is −6 dB, −7 dB, and −7.78 dB when number of CDM groups without data is 4, 5, and 6, respectively.

13. The UE of claim 12, wherein CDM groups, where the number of CDM groups without data is 4, 5, and 6, are CDM groups {0,1,2,3}, {0,1,2,3,4}, and {0,1,2,3,4,5}, respectively.

14. A base station, comprising:
at least one memory; and
at least one processor coupled with the at least one memory and configured to cause the base station to:
transmit a configuration of Phase-Tracking Reference Signal (PTRS) and configuration of Rel-18 Demodulation Reference Signal (DMRS) for a data transmission, wherein the data transmission is a Physical Downlink Shared Channel (PDSCH) transmission with more than six layers, or a Physical Uplink Shared Channel (PUSCH) transmission with more than four layers;
determine a ratio between an Energy Per Resource Element (EPRE) of a PTRS transmission and an EPRE of the PDSCH transmission; and
determine a PUSCH to PTRS power ratio of the PUSCH transmission.

15. A method performed by a user equipment (UE), the method comprising:
receiving a configuration of Phase-Tracking Reference Signal (PTRS) and configuration of Rel-18 Demodulation Reference Signal (DMRS) for a data transmission, wherein the data transmission is a Physical Downlink Shared Channel (PDSCH) transmission with more than six layers, or a Physical Uplink Shared Channel (PUSCH) transmission with more than four layers;
determining a ratio between an Energy Per Resource Element (EPRE) of a PTRS transmission and an EPRE of the PDSCH transmission; and
determining a PUSCH to PTRS power ratio of the PUSCH transmission.

16. A processor for wireless communication, comprising:
at least one controller coupled with at least one memory and configured to cause the processor to:
receive a configuration of Phase-Tracking Reference Signal (PTRS) and configuration of Rel-18 Demodulation Reference Signal (DMRS) for a data transmission, wherein the data transmission is a Physical Downlink Shared Channel (PDSCH) transmission with more than six layers, or a Physical Uplink Shared Channel (PUSCH) transmission with more than four layers;
determine a ratio between an Energy Per Resource Element (EPRE) of a PTRS transmission and an EPRE of the PDSCH transmission; and
determine a PUSCH to PTRS power ratio of the PUSCH transmission.

17. The processor of claim 16, wherein the PTRS transmission and DMRS transmission with Time Division Orthogonal Cover Code (TD-OCC) are not occurring simultaneously.

18. The processor of claim 16, wherein for a number of layers of a PDSCH transmission with DMRS associated with a PTRS port with eight layers, an EPRE ratio is 9 dB if an epre-Ratio is ‘00’.

19. The processor of claim 16, wherein for a value of a parameter for configuring a power boosting factor for each PTRS port of the PUSCH transmission being “00”, the PUSCH to PTRS power ratio is 7 dB, 7.78 dB, and 9 dB for 5-layer, 6-layer, and 8-layer full coherent codebook based PUSCH transmission, respectively.

20. The processor of claim 16, wherein for a value of a parameter for configuring a power boosting factor for each PTRS port of the PUSCH transmission being “01”, the PUSCH to PTRS power ratio is 7 dB, 7.78 dB and 9 dB for 5-layer, 6-layer, and 8-layer PUSCH transmission, respectively.
